(19) United States
(12) Patent Application Publication
(10) Pub. No.: US 2003/0095648 A1
(43) Pub. Date: May 22, 2003

(54) Fault-tolerant remote reprogramming for a patient-worn medical device

(75) Inventors: Thomas E. Kaib, North Huntingdon, PA (US); Thomas T. Nguyen, Pittsburgh, PA (US); Edward J. Donnelly, Allison Park, PA (US)

Correspondence Address: Bryan H. Opalko, Esquire, Buchanan Ingersoll, P.C., One Oxford Centre, 20th Floor, 301 Grant Street, Pittsburgh, PA, 15219, US

(73) Assignee: LIFECOR, Inc., Pittsburgh, PA (US)

(21) Appl. No.: 10/305,515

(22) Filed: Nov. 27, 2002

Related U.S. Application Data
(63) Continuation-in-part of application No. 10/197,159, filed on Jul. 16, 2002.
Application No. 10/197,159 is a continuation of application No. 09/624,275, filed on Jul. 24, 2000, now abandoned.
(60) Provisional application No. 60/157,881, filed on Oct. 5, 1999.

(51) Int. Cl. H04M 11/00

(52) U.S. Cl. 379/106.02

(57) ABSTRACT

A method of remotely updating or upgrading the operating parameters of the wearable medical device is also provided. The method will automatically update the operational software of the device during a data download sequence. During such a download sequence, after the data has been downloaded, a remote server at the remote location will query the device's current operating software version which is stored in a main memory area of the device. If a software upgrade is needed, the method will clear an alternate memory area in the device. The remote server will then begin downloading the new (upgraded) operating software to the medical device where it will be stored in an alternate memory area. After downloading is complete, the integrity of the new operating software in the alternate memory area is verified by performing a cyclic redundancy check (CRC) or other error checking method If the new operating software passes verification, the method will add a new entry to a boot vector table in the device that will cause the medical device to execute the new operating software located in the alternate memory area during the next power-up sequence. The medical device will continue to execute its current operating software version until the device power is cycled. The new operating software will self-install during the next power-up sequence. In the event of a failure during the updating sequence, a valid operating software image is always available from either the main or alternate memory areas.

### CROSS-REFERENCE TO RELATED APPLICATIONS

This application is a continuation-in-part application of patent application Ser. No. 10/197,159 filed on Jul. 16, 2002, which is a continuation of patent application Ser. No. 09/624,275 filed on Jul. 24, 2000, which is based on and claims the benefit of provisional patent application Ser. No. 60/157,881 filed on Oct. 5, 1999, all entitled “Data Collection and System Management for Patient-Worn Medical Devices”, the entire disclosures of which are hereby incorporated by reference herein.

### FIELD OF THE INVENTION

The present invention is directed generally toward patient-worn medical devices and, more particularly, toward the ability to remotely update the software utilized by a patient-worn medical device while the device remains in operation.

### BACKGROUND OF THE INVENTION

Modern medical technology is available for allowing ambulatory patients to function in a normal day to day environment, even while requiring the monitoring of certain health and physical parameters. In addition to this, it is possible to have therapeutic devices or drugs automatically provided to the patient when in time of need. These medical devices are typically worn by the patients to provide the monitoring of a variety of conditions. These devices may also provide for the automatic treatment when the monitoring device detects that such treatment is required. Examples of such devices include a wearable cardioverter defibrillator, cardiac monitors and infusion pumps for the treatment of diabetes. With respect to the wearable cardioverter defibrillator (WCD), an example of such a device is disclosed in U.S. Pat. No. 5,741,306 which issued on Apr. 21, 1998, and in its companion continuation-in-part patent application Ser. No. 09/054,714, filed on Apr. 13, 1998, which patent and application are assigned to the assignee herein and are hereby incorporated by reference in their entirety.

By way of brief explanation, the WCD device provides a patient-worn energy delivery apparatus for imparting electrical therapy to the body of a patient in response to an occurrence of a treatable condition. The apparatus includes a voltage converter for converting electrical energy from an initial voltage to a final voltage at a plurality of charging rates, and a defibrillator coupled between the converter and the patient so as to impart the electrical energy to the patient. The defibrillator produces preshaped electrical pulses, such as defibrillation pulses and cardioversion pulses, as determined by the monitoring of the patient. With electrodes appropriately placed on the patient, the WCD device monitors the condition of the patient's heart on a continual basis to determine if the patient requires either a defibrillation pulse or a cardioversion pulse to restore normal heart function.

While the patient may be using any of the above-identified medical devices, it is important that the data collected from the device be analyzed by the care giver. Typically, this means that the patient must travel to the hospital or clinic in order to exchange the device for a different one so that the data collected on the turned-in device can be read and analyzed. Alternately, the patient must at least drop off some sort of memory module, be it either a tape or a paper printout, so that the physician can analyze the data and thus the health of the patient. However, this necessitates that the patient again travel to the hospital in order to turn in the memory module and have this procedure done.

Moreover, these medical devices have traditionally required programming or configuration at the center which originally dispenses the device to the patient who, as stated above, must later return to that center for review of the collected data. When the components of the device need to be upgraded or changed due to, for example, expiration of their normal useful life, such as replacement of a battery or any other electronic component such as a solid state memory the patient again must travel to the dispensing center in order to have this routine maintenance performed. Many times such an update to the device merely involves improving or upgrading the device's operating software so that the monitoring and therapy device works in a more efficient and helpful manner. Again, the patient must travel to the dispensing center to have the device's operating software upgraded.

With digital technology, it is possible for such a device to be able to “download” the data via telephone line, for example, from the patient's home to a remote location. With this type of system, the patient data is collected into a solid state memory in the device which can then be transmitted via a telephone line and modem to the hospital or physician's office for analysis of the data by the physician.

It would be advantageous, therefore, if the frequency of the number of trips that the patient must make to the dispensing center, such as a hospital or physician's office, is minimized. Remote transmission of patient data and diagnostic information related to the operation of the device would help eliminate some of the heretofore repetitive trips that the patient must make to the dispensing center.

Moreover, remote upgrading of the operation of the device, such as an upgrade of the device's operational software, would more efficiently result in the most therapeutically effective device being available to the patient as quickly as possible. However, there are inherent risks associated with performing software, or firmware, upgrades from a remote location. During such an upgrade, the medical device is susceptible of being rendered defective or inoperable if the upgrade programming sequence is interrupted or fails to complete properly. For medical equipment and devices that provide critical functions, the risk of the device being rendered inoperable is an important concern.

The present invention is directed toward overcoming one or more of the above-mentioned problems.

### SUMMARY OF THE INVENTION

The wearable medical device is operatively connected to the patient and the predetermined patient medical information is recorded in a storage means of the wearable medical device. An outlet port of the wearable medical device is operatively connected to a communications system in order to transmit the predetermined patient medical information to a health care provider by means of the communications system, and the patient medical information is recorded in an information database at the health care provider location. Access to the patient medical information is provided to predetermined individuals, such as medical personnel for monitoring the patient's health and/or technical personnel for monitoring the operation of the device to ensure that it is operating correctly. Where the wearable medical device is a cardiac defibrillator and monitor, the step of recording the predetermined patient medical information includes recording electrocardiograms (ECGs) of the patient's heart rhythm.

In a system for monitoring patient medical information, the system includes a wearable medical device operatively attached to a patient for monitoring and storing predetermined medical parameters. The medical device is connected to a communications network, which in turn is connected to a health care provider to thereby operably exchange information with the patient database at the health care provider, and/or with technical personnel for monitoring and upgrading the performance of the medical device.

A method of remotely updating or upgrading the operating parameters of the wearable medical device is also provided. The method will automatically update the operational software of the device during a data download sequence. During such a download sequence, after the data has been downloaded, a remote server at the remote location will query the device's current operating software version which is stored in a main memory area of the device. If a software upgrade is needed, the method will clear an alternate memory area in the device. The remote server will then begin downloading the new (upgraded) operating software to the medical device where it will be stored in an alternate memory area. After downloading is complete, the integrity of the new operating software in the alternate memory area is verified by performing a cyclic redundancy check (CRC) or other error checking method. If the new operating software passes verification, the method will add a new entry to a boot vector table in the device that will cause the medical device to execute the new operating software located in the alternate memory area during the next power-up sequence. The medical device will continue to execute its current operating software version until the device power is cycled.

When the medical device power is cycled and the device initiates its next power-up sequence, the most recent entry in the boot vector table will point to the new operating software in the alternate memory area, and the new operating software will be loaded into a runtime memory area for execution. After the new operating software has begun executing and performing various start-up operations, the current operating software version is erased from the main memory area, and the new operating software version is copied from either the alternate memory area or the runtime memory are to the main memory area. Successful copying of the new operating software to the main memory area is verified by performing a CRC calculation or other error checking method, and a new entry is added to the boot vector table that will cause the medical device to execute the new operating software version from the main memory during the device's next power-up sequence. The new operating software version located in the alternate memory area may then be erased.

The inventive method includes a built in fault-tolerance such that reprogramming interruptions or faults will not result in device malfunction. A valid software version, new or current, can always be located and executed by the medical device from either the main or alternate memories. The worse case scenario that can occur as a result of a reprogramming or upgrading fault is the continued operation of the medical device using the original or current version of the operating software.

It is an object of the present invention to provide a medical device which can be worn by a patient and which provides for the interactive transfer of data and information from the device to a remote center, such as a doctor's office, for monitoring of both the patient and the device itself.

It is a further object of the present invention is to provide a medical device which can be upgraded remotely from the device dispensing center in order to reduce the number of personal visits by the patient to the dispensing center.

It is yet a further object of the present invention to provide a medical device capable of remote upgrading of its operational software in a timely manner without device usage interruption, equipment replacement or field service/manufacture personnel involvement.

It is still a further object of the present invention to provide a fault-tolerant method to remotely upgrade the operating software of a wearable medical device while the device remains in operation monitoring a patient.

It is an additional object of the present invention to provide a method to remotely upgrade the operating software of a wearable medical device in which reprogramming interruptions or faults will not result in device malfunction.

It is yet another object of the present invention to provide a patient-worn medical device which has the capability to transfer and receive information and data with a remote center via telephone dial-in access, direct Internet access or radio frequency communications.

Other aspects, objects and advantages of the present invention can be obtained from a study of the application, the drawings, and the appended claims.

### BRIEF DESCRIPTION OF THE DRAWINGS

FIG. 1 is an overall schematic diagram of the interconnected data transfer and remote access modules of the present invention;

FIG. 2 is a schematic representation of one embodiment of a means for connecting a wearable medical device with a communications network;

FIG. 3, consisting of FIGS. 3a and 3b, is a representation of computer screens for inputting patient data and various medical information;

FIG. 4 is a representation of a screen display indicating a patient adverse event as recorded by a wearable medical device;

FIG. 5 is a representation of a screen display showing an ECG report for a wearable cardiac defibrillator;

FIG. 6 is a representation of a screen display for monitoring correct patient use of the wearable medical device;

FIG. 7 is an illustration of the memory area layout for a WCD device incorporating the inventive reprogramming method;

FIG. 8 is an upgrade sequence flow diagram of the inventive reprogramming method; and

FIG. 9 is a table illustrating the possible fault conditions that can occur during various steps in the updating sequence of the inventive reprogramming method.

### DETAILED DESCRIPTION OF THE INVENTION

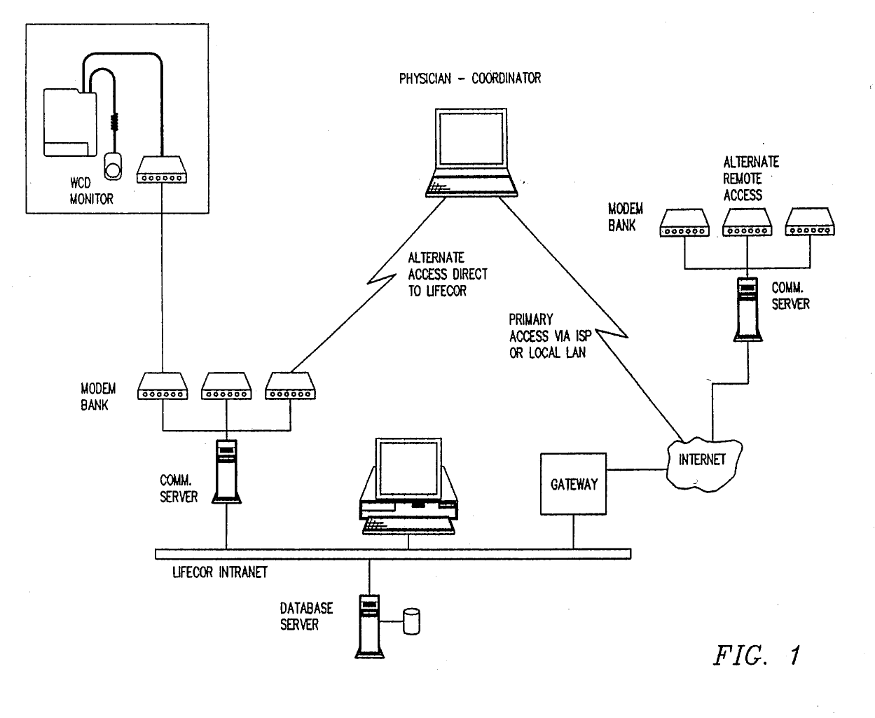

Referring now to the drawings in detail, FIG. 1 shows an Internet based data management architecture for remote data collection and system management for patient-worn medical devices. The invention employs the use of data modems which employ a variety of transmission vehicles, such as, for example, wired telephones, radio frequency transmissions through dedicated or cellular networks or infrared transmission, to provide for data collection and management of a patient-worn medical device. The Internet or other data network is used to make this data available to physicians and their staff, making it possible to review the data from any location and manage the use of the device. Passwords, encryption and other security devices allow control of the data and provide for patient privacy. In this manner, data need only be sent from the monitoring device to one location on the web server, which location can then be accessible by physicians or device technicians from any location to review the data collected to ensure both the health of the patient and the proper operation of the patient-worn device.

Preferably, the information for the operation of the device is collected at a central location, such as a performance analysis and post-market surveillance operation, which is maintained by the equipment manufacturer. Remote, dial-in access is available to this central location by both the patient, physician and device maintenance personnel. The patient can download both the patient monitored data as well as operations data for the device to the central location, which data can be accessed by the physician and/or the maintenance personnel. In addition, the physician can access this data from anywhere by using a common Internet web browser to access the central location via the Internet. The physician can monitor the patient's health data, such as, for example, electrocardiogram (ECG) data which has been downloaded from the patient-worn device. Additionally, since device performance data can be downloaded from the central location, the correct operation of the patient-worn medical device can be monitored to ensure that the physician is receiving and analyzing proper patient health information.

In this manner, a variety of data collection features can be provided. These include the automatic or manual transmission of sensor data, such as, for example, ECG signals from a halter monitor, for collection of the data in a database which is preferably a relational database for review and analysis over the course of the monitoring of the patient. In addition, the patient can be prompted for the manual transmission of data either on a predetermined basis or randomly by the physician if the physician determines that a particular event has been detected and additional information is required. The use of dedicated modems or industry standard protocols, such as TCP/IP, allows the use of commercial networks for transmission, which networks can be protected from unauthorized review of information via passwords, encryption or other security devices. In addition, automatic or manual transmission of equipment performance data, such as battery status, system faults or failures, capacity, treatments provided and sensor function, can be presented to the central location for proper analysis. Automatic or manual transmission of the results of an analysis performed on the collected data, such as review of arrhythmia events, can then also be provided back to the patient or other physicians. If it is determined that a message is to be sent to the patient prompting him or her to perform certain functions in order to correct any nonconformities that a physician or maintenance personnel detects, automatic or manual transmission of patient compliance and use data can also be sent back to the central location for review by the physician or maintenance personnel to ensure that the patient has complied with whatever instructions either of these groups may have provided.

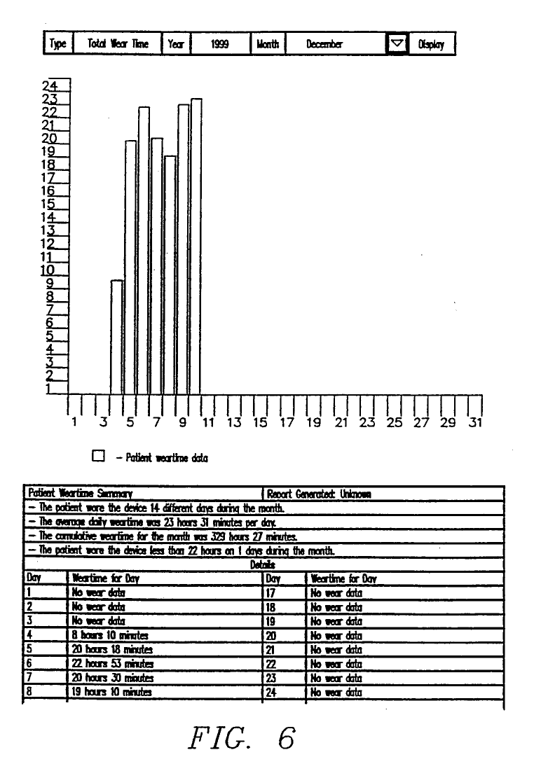

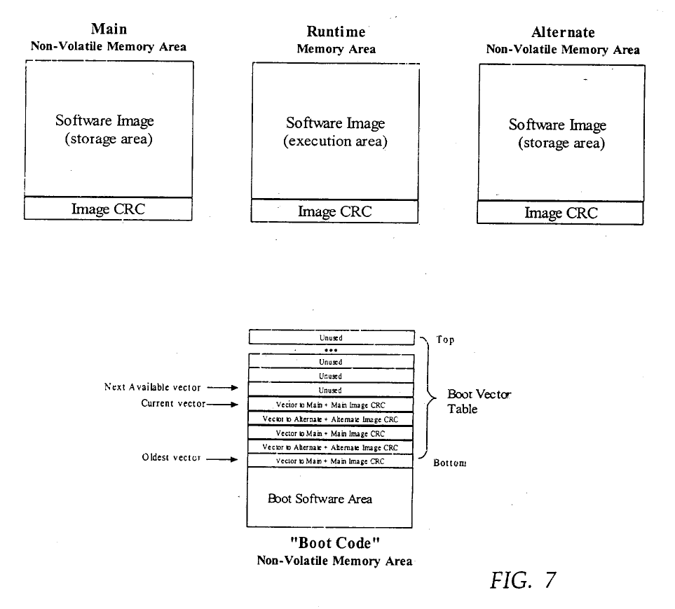

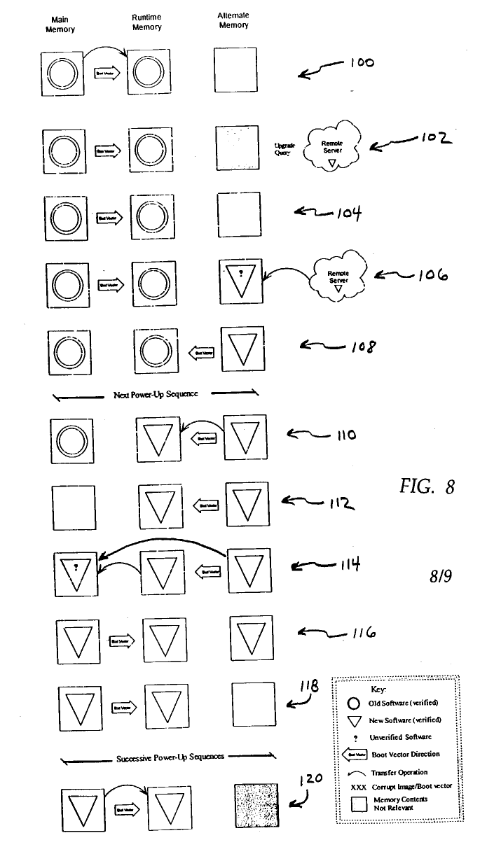

For example, if it is determined through review and analysis of ECG signals received from the patient that the garment or device has not been properly positioned on the patient, such as through excessive “noise” in the ECG signals, a message can be sent to the patient advising him or her that the garment or device needs adjustment in order to insure proper placement of the electrodes. “Noise” can also be generated by the physical characteristics of a particular patient, such as body shape, how the electrodes are positioned, body size, etc. Also, with reference to FIG. 6, the average wear time data for which the patient has worn the device can be analyzed to determine patient compliance. In this way, complete medical profile information can be received from the patient for analysis by the physician and/or maintenance personal to insure the health of the patient as well as the correct operation of the device.

In the event it is determined that the device is not operating properly, even though the patient is wearing it properly and for the prescribed period of time, the data can be analyzed and patient parameter changes, such as wear-time recommendations and placement of electrodes, can be implemented for the proper operation of the device for that particular patient. Through the on-line data collection system of the present invention, software upgrades can be transmitted directly to the patient's device during, for example, a data download, or the patient can be instructed to implement hardware upgrades during his or her next visit to the physician. Also, periodic battery replacement and charging instructions can be given to the patient to insure proper operation of the device. Additionally, data received from a multitude of patients can be analyzed to develop trends in device operation for future product improvements or enhancements.

In order to download the data, the patient-worn medical device, such as the WCD, can be connected to an external modem for telephonic connection to the central location. Alternatively, the device may include an internal modem and associated jack for connection to any standard phone line. The device can be programmed to include the appropriate telephone number of the central location. Once the device, through an external or internal modem, has been connected to the phone line, the patient need only initiate a data send function which can initiate the dialing and remote connection procedures. When connection is established between the patient-worn device and a web server at the central location, the data can be downloaded to that site for retrieval by the patient's physician and/or technical personnel for analysis of the data. Alternatively, direct internet access or radio frequency (RF) communications can be used to eliminate the need for, or used in addition to, dial-in telephone access.

In addition to the collection and transmission of data related to the operation of the device and/or the patient's health, system management features are also provided. In this way, the distribution of the collected data and any reports and/or analysis can be performed through the Internet or other dedicated communications lines to remote computers used by the prescribing physicians or their staff. Thus, for example, if a physician requires either a second opinion or further review of specific data, that data can be retransmitted to another care giver for the proper analysis and consultation between health care professionals. Analysis of equipment performance data may indicate the need for service or repair, which a database type gathering of information would allow maintenance personnel to observe trends and provide analysis for preventive service actions, not only for a particular monitoring device but for any and all devices which may be in use in the field. Analysis of patient data and the results of any remote analysis allow the prescribing physician to adjust treatments or therapies, either through updating the operation of the device by changing the software via the Internet or by prescribing different medicines and notifying the patient that a different prescription is already waiting and available for him or her for pick-up or delivery. Since the data is continually collected by the device, the physician can analyze the compliance and use data to allow intervention by the prescribing physician if the device is not being used by the patient or is being used improperly.

In addition, the device parameters or software for the patient-worn medical device can be updated automatically when contact is made by the patient for the periodic data download to the central location. This update may be specific to the particular patient and occur at the direction of the prescribing physician after review of performance and patient data. This update may also be of the general update or upgrade type which is applied to all devices in the field. The data collected from the patient may be considered in preprogramming replacement devices prior to them being sent to particular patients, so that there is no need for the patient to return to the dispensing center, physician's office, hospital, pharmacy, etc., if service of the device is required. In the event that a device problem requires regulatory action or recall, these systems can be easily located since the continual analysis of patient compliance and use data allows for automatic equipment tracking. These systems may be automatically located through the central data location and can be either updated or disabled remotely when contact is established, or the patient can be notified that a recall is in effect and needs to return to the dispensing center as soon as possible. In addition to allowing action to be taken more quickly, the operational status of individual devices may be tracked. By continually monitoring the proper use of the devices, the dispensing center procedures can be continually updated for purposes such as billing and continual monitoring of the device to ensure that the physician's instructions are being fully complied with by the patient.

Since each of the parties (patients, physicians, maintenance personnel and equipment manufacturer) can access the data on an as needed basis, correct operation and use of the device by the patient can be ensured. By continually monitoring patient data, if a physician determines, for example, that certain anomalies continue to occur in different devices or monitors provided to different patients, the physician can check with maintenance personnel and those personnel can access the data to ensure that it is the equipment that may not be operating correctly and not that each patient is encountering the exact same medical condition simultaneously. This type of trend analysis is helpful in both providing proper patient care as well as providing a device which is most effective for monitoring and treating patients. Thus, the freedom that the patient enjoys by having a patient-worn device is increased by eliminating endless trips to and from the dispensing center to both check the health of the patient and for routine maintenance which, according to the present invention, can be done from a remote location.

As shown in FIG. 1, the data collection and system management design of the present invention allows the various concerned persons to have access to the central location, such as a web server, for the exchange of data and information. The Internet serves as a “gateway” for enabling each of the parties to be linked across the information network. The modem, or other data transfer technology, used as part of the wearable medical device can dial into a central location, such as an Intranet operated, for example, by the assignee of the present invention, by means of a communication server. Multiple party access to the host location by patients can be provided by a modem bank.

At the central location host, a searchable database, such as an SQL Database, can be provided to allow for performance analysis and post-market analysis of the overall operation of all of the patient-worn medical devices currently and previously used by patients. For example, device technicians and engineers can search for error-trends or other operational characteristics of the devices to monitor proper operation of the medical devices. Alternatively, if any particular device has returned an error or other message to the central location, a technician can analyze the operation of that device and either recommend a course of action for the patient to correct the problem, transmit software instructions directly to the device to upgrade its operation, or instruct the patient to return the device to the distribution center to exchange it for a properly operating machine. Broadcast messages may also be sent to all of the devices for implementing courses of actions should a generic problem or fault be detected in the operation of the devices.

At the caregiver or doctor's office, the patient's physician can periodically review any particular patient's data by logging onto the central location and using a conventional web browser, such as Netscape Navigator or Microsoft Internet Explorer. Once the appropriate password or other security procedures have been undertaken, the physician can download patient data for medical analysis, such as a periodic review of ECG data or for specific review of a detected arrhythmia event or other machine implemented therapeutic action. After analysis of the patient medical data, the physician can prescribe remedial action for the patient in a variety of ways. For example, this can be accomplished by means of electronic data transmission to the patient at the next scheduled data download, an instantaneous message to the patient indicating an immediate course of action, or even dispatching emergency personnel to the patient's home. The physician can also contact the central location host in the event that there is a concern with the proper operation of any of the devices. Even in those situations where the physician is not physically located at his or her office, by using a communications network, such as the Internet, the physician can obtain access to patient data, especially in an emergency situation, from virtually anywhere in the world. Another advantage to this remote access capability is that a physician can consult with a specialist, by either granting that person access to the data or retransmitting the data directly to the specialist over the Internet, such that all of the parties can have access to the data simultaneously. Alternatively, a web-based conference can be conducted by persons located at various locations by each of the parties accessing the same secure website to analyze the data.

In order to prepare a wearable cardiac defibrillator (WCD) monitor to transmit information over the Internet or other communications network, it must first be programmed to include the specific patient information. In order to perform this initial programming, the following steps are performed.

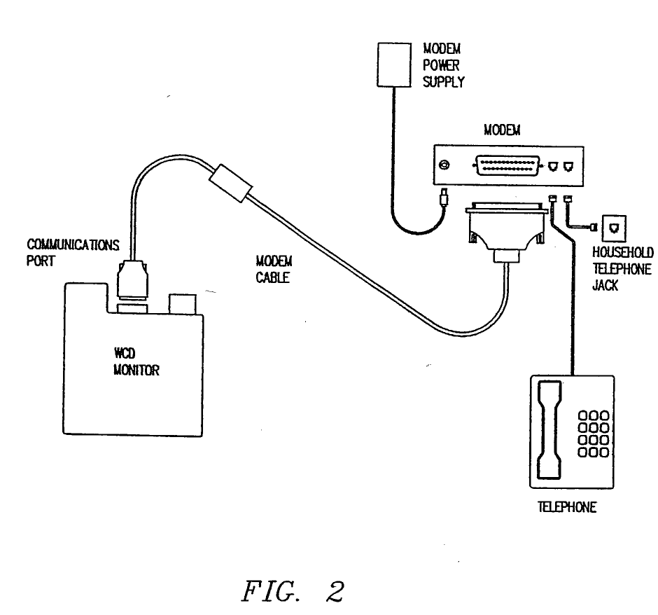

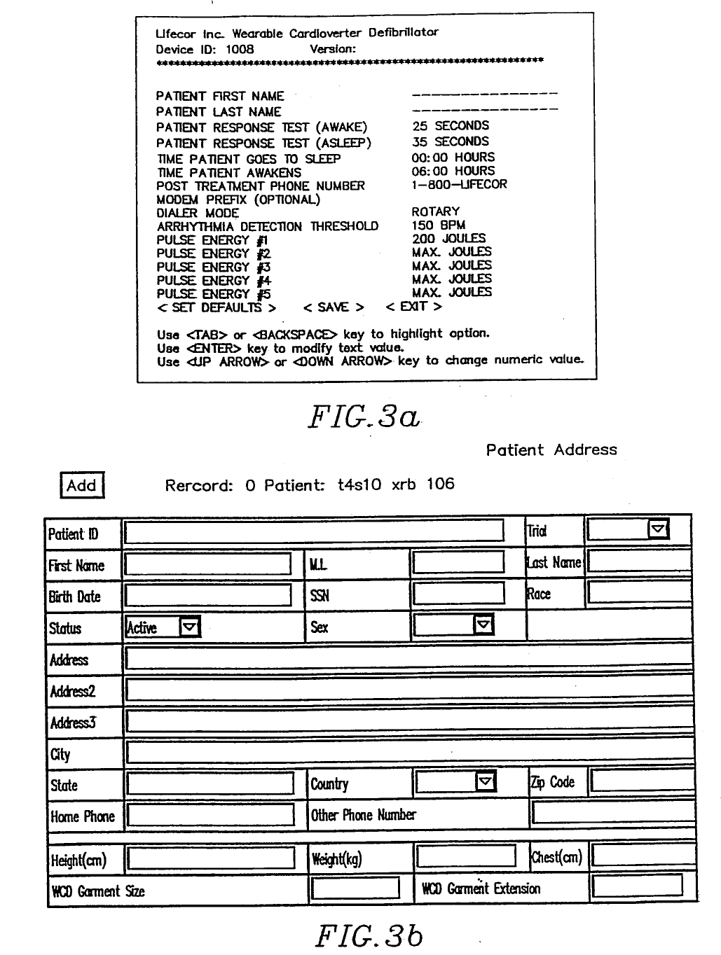

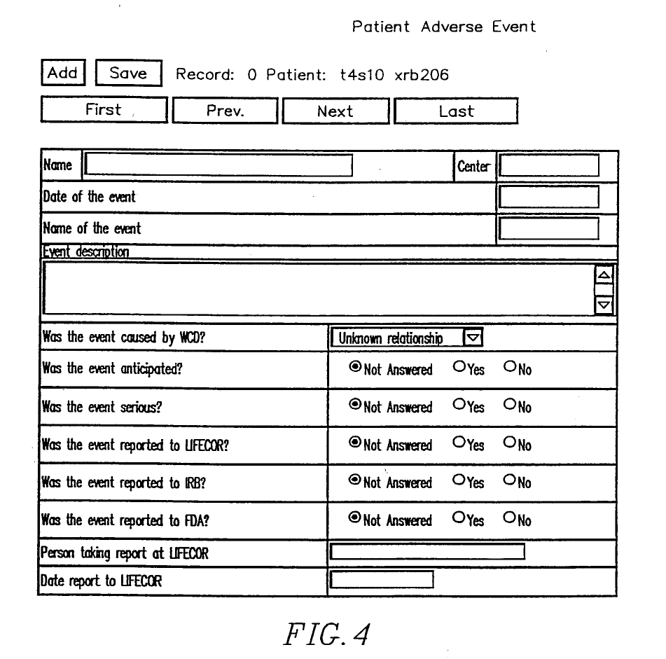

The WCD must first be connected to a personal computer (PC) in order to program the initial patient information. This is done by use of a computer cable which connects the monitor to, for example, a serial port of the PC. This is shown in FIG. 2. A program is initiated on the PC which will then program the information into the computer memory of the WCD monitor. When setting up a new patient, the current time and date are entered into the WCD monitor. When configuring the monitor for a new patient, a “set-up new patient” operation is performed. The monitor is programmed with the patient's full name, which can then be used when transmitting data to identify the patient directly. When the patient information is entered, the particular patient settings for that patient are then input into the monitor's memory. As shown in FIG. 3, there are numerous data points that must be input. On-screen instructions inform the service provider as to how to modify the particular patient data. Some of these parameters may include whether or not a modem prefix is required to dial from a patient's residence, or whether the phone is digital (tone) or rotary (pulse). After these initial patient parameters are installed, the patient baseline ECG data is input into the monitor.

The monitor must first be disconnected from the PC by disconnecting the computer cable from the monitor. The patient is at this time wearing the monitor such that the electrodes are placed on appropriate spots on the patient's body. I(he monitor is then activated to record the patient's baseline ECG signals, which will be displayed on the monitor. Generally, the monitor will record the patient's heart rhythm for a period of from about 45 seconds to about 5 minutes to initialize, as the monitor device learns the patient's baseline ECG signals. Once the monitor has performed this function, a message is displayed which states that the baseline recording is complete and that the monitor can begin normal functioning. In the event that the patient has a heart rhythm that is difficult to learn, the monitor provides a message such as “baseline failed” and patient baseline recording can begin again. In the event that the electrodes are not properly placed or positioned on the patient's body, a message is displayed which informs the user to properly position the electrode belt for the wearable defibrillator. Once the patient's baseline information has been recorded, this information must then be sent to the device manufacturer's database server via the modem.

The WCD system also includes a modem cable for connecting the monitor to an external modem. Alternatively, an internal modem may be provided in the monitor. The appropriate phone lines are connected and the modem is connected to the phone line and/or a common household telephone jack. When the telephone connections have been made, the modem is connected to the power supply and turned on to begin the information transfer. Preferably, the patient's database resides on the Lifecor's Intranet database server to receive the various patient information. When the modem and monitor are properly connected a message is displayed to indicate that it is permissible to now send data. The patient can then initiate data transfer by pressing the appropriate button on the monitor such that the modem begins dialing into the data center's database server. During data transfer, a message is displayed that such data transfer is in progress. When transfer is complete, the appropriate message is displayed indicating that the data transfer is complete and that modem should now be disconnected. In the event of any problem with the data transfer, a message is displayed and a further attempt to transmit data should be performed. Upon successful transfer of data, the monitor is disconnected from the modem.

Once the patient information has been baselined and the monitor information has been sent via modem to the Lifecor database server or other communications network data center, the Internet can then be used to enter and/or review patient data. When entering this website, a user is prompted to enter their login name and password in order to enter the “WCDNET”. Upon successfully entering the website, a patient list is displayed to the user such that patient information can be accessed in several ways. Patient information can either be accessed directly by patient name or by an identified category, such as patient identification number, last name, first name or serial number of the device, and a search function performed. For example, if the patient's name begins with the letter R, this can be input into the appropriate area on the patient's record and a search done for all patient's who last name begins with the letter R. Once the desired patient is selected, the patient screen is displayed. This allows the user to enter more patient information, such as address, phone number, height, weight, chest circumference, and garment and extension size for the WCD monitor belt. Once this information is input, it is saved within the communications network data center or database server. Next, appropriate patient demographic and medical information can be input. Typical screen displays for inputting various patient information are shown in FIG. 3. Once the entire patient initial information is input, this data is saved to be compared against later downloads of information from that patient.

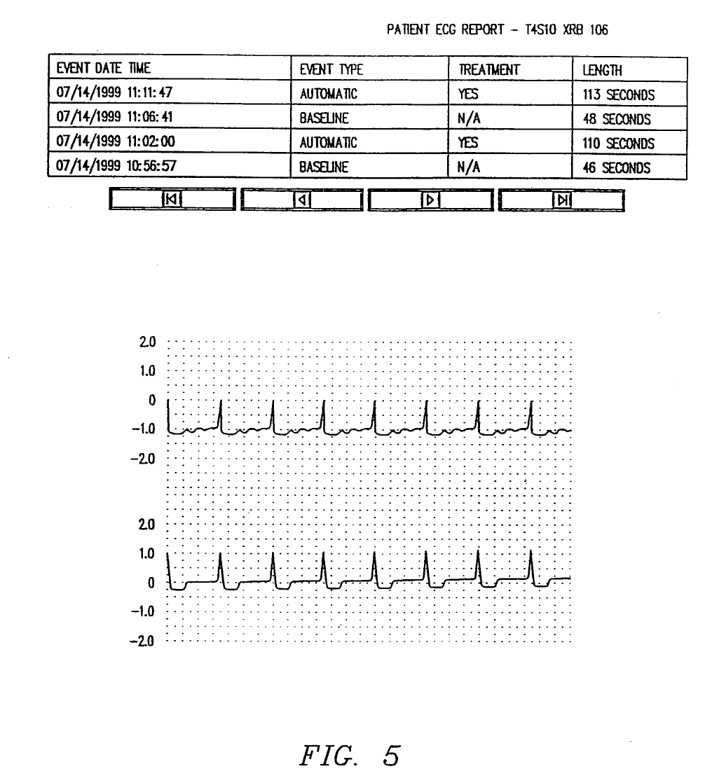

Should an “adverse event” occur, such a screen is also provided for the health care provider to input the pertinent information, as shown in FIG. 4. These include the date of the adverse event, the nature or description of the event, and other pertinent event information.

In order to view the patient's electrocardiogram (ECG) recordings, the “ECG report screen” as shown in FIG. 5 is accessed. The ECG recordings are listed by date, time, type, treatment (if applicable) and length.

To see the patient's compliance record, the “compliance screen” as shown in FIG. 6 is accessed. This shows, for example, how many hours out of each day the patient has actually been wearing the monitor such that patient data is being collected and input to the system.

In order to provide the patient information into Lifecor's Intranet site database, the patient is prompted periodically, such as on the order of every 7 days, to connect his/her monitor to the modem for transfer of information to the database. The message is displayed on the patient's monitor indicating that it is time to connect to the modem to transfer the data to the database server. This communication is performed as set forth above.

The monitor records electrocardiogram data which is to be sent to the monitoring service. The patient is thus prompted to transfer this data to the physician so that active monitoring of the patient by a health care provider can be performed.

During such data transfers, there may be updates or upgrades required to be made to the patient's monitoring device, which will be readily apparent since the patient's device serial number or other identifying data is also transmitted with that patient's data. Additionally, instructions can be sent from Lifecor's web site to the patient's monitor. These may include, for example, software updates for the monitor, alerting the patient to product recalls, if necessary, and instructing the patient to return the monitor to the health care service provider for additional on-site maintenance and upgrading of the hardware of the device.

For an implantable device, a transcutaneous transmitter is used to communicate with the implanted medical device; such as a pacemaker. Operating parameters can be updated, such as these previously described above, according to the unique operating characteristics of the implanted device within a particular patient. As the patient's medical information is analyzed from time to time by a physician, these operating parameters can be adjusted in order to more fully serve the patient's medical needs. For a pacemaker, for example, the transcutaneous transmitter can be placed over the area on the patient's body where the device is implanted, and radio frequency (RF) communications between the pacemaker and the transmitter can be established. The transmitter is in turn operatively associated with global communications network, such as with a base station having a modem and other communications hardware as is well known in the art.

Additionally, the wearable device may also communicate with the network via a base station. Rather than having to remove the wearable device or directly plug it into the communications device, an RF or infrared communications link can be used. In this way, should the device detect an emergency situation the device can automatically establish a communication link with the physician's office, for example, or call emergency personnel directly to the patient's location. Such automatic communication is particularly important when the emergency situation is detected when the patient is asleep or unconscious. Therefore, the present invention provides distinct and unique advantages for patient-worn medical devices by integrating data collection and system management functions into a central location for the proper operation of these devices.

As previously noted, the wearable medical device of the present invention can automatically receive software and other operating parameter upgrades or updates when contact is made by the patient for the periodic download of data to the remote location, e.g., health care provider. It is important during such remote upgrades that the medical device not be rendered defective or inoperable if the upgrading sequence is interrupted or fails to properly complete. The inventive fault-tolerant upgrading method of the present invention provides the capability to remotely update the software, or firmware, of a medical device, such as a wearable cardioverter defibrillator, while the device remains in operation monitoring a patient. At the very worst, the device will continue to use its original operating software version should a fault occur during reprogramming or upgrading.

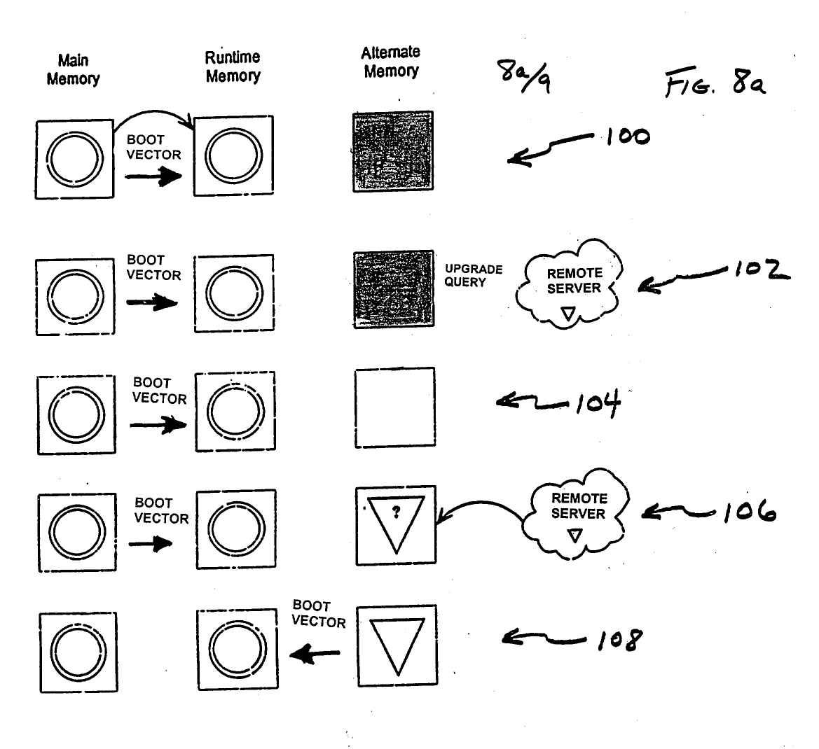

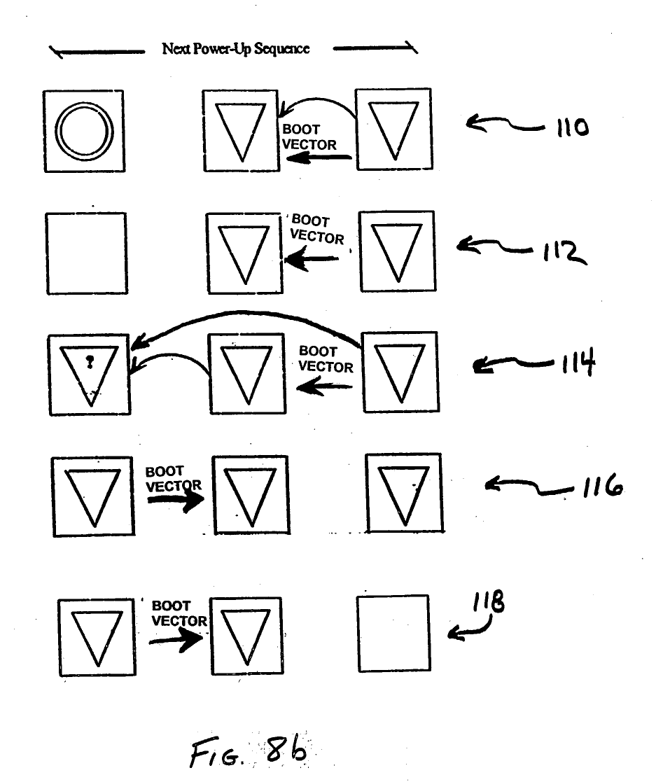

As shown in FIG. 7, the WCD device utilizing the inventive method includes four separate memory areas. These areas include a main memory area, a runtime memory area, an alternate memory area and a boot code memory area. The boot code memory area is a defined area of Flash or other non-volatile memory that contains the power-up boot loader code (“boot code”) and a boot vector table. The boot code is typically factory installed and loads the operating software for the device at power-up of the device. The boot code will typically not be upgraded by the inventive remote reprogramming method. The main memory area is a defined area of the Flash or other non-volatile memory that is reserved for the device operating software, or application code. During a normal power-up sequence of the device, the boot code will copy the operating software stored in the main memory area into the runtime memory area for execution.

The runtime memory area is a defined area of the memory that is typically designated for the device operating software. At power-up of the device, the operating software, which will control operation of the device, is loaded into the runtime memory area and, after the operating software has been loaded, the software application is executed from the runtime memory area. The alternate memory area is a-defined area of Flash or other non-volatile memory that is allocated for new operating software, or application code, during the software update sequence. During the software update sequence, the boot code may copy the operating software from the alternate memory area to the runtime memory area for execution.

Depending upon the hardware implementation of the WCD device, it is possible to omit the runtime memory area. The inventive method described herein may be implemented utilizing, only the main, alternate and boot code non-volatile memory areas. While the runtime memory area, may be omitted, including a separate runtime memory area can help reduce the number of components required to implement the inventive method.

As shown in FIG. 7, the boot vector table is a section of the boot code memory area that contains entries, or vectors, which are used by the boot code to determine the appropriate memory area that contains the current device operating software, or application code. A boot vector entry points to, or identifies, a non-volatile memory location, either the main or alternate memory areas, and includes the CRC value of the corresponding operating software, or firmware image, stored in the identified memory location. Each time a valid operating software image is written to either the main or alternate memory areas, a new boot vector is appended to the boot vector table allowing the device to boot from the new operating software location. As shown in FIG. 7, boot vectors are not written over or erased from the boot vector table, but rather, new boot vectors are simply added to the boot vector table. The boot code will typically look at the most recent boot vector entry first when searching for a boot vector that points to valid operating software. In this manner, if the most recent boot entry in the boot vector table does not include a valid boot location vector, the boot code can then examine previously input boot vectors to locate a valid boot location vector.

Upon power-up of the WCD device, the boot code will scan the boot vector table looking for a valid boot location vector. Once a valid boot location vector is found, the boot code validates the operating software image in the memory area identified by the boot vector. If the operating software image is valid, the boot code copies the operating software image from the identified memory area into the runtime memory area for execution. The boot code then transfers execution control to the operating software that has been copied into the runtime memory area. If, at power-up, the boot code cannot find a valid boot location vector the boot code will then attempt to find a valid operating software image by performing a CRC test, or other error checking method, on the main memory area. If a valid operating software image is not found in the main memory area, the boot code will then perform a CRC test, or other error checking method, on the alternate memory area. Once validated, the operating software image is then copied into the runtime memory area for execution. Unless there is a hardware failure, the inventive reprogramming method ensures that there will always be a valid operating software image in either the main or alternate memory areas.

If the boot code detects an invalid boot location vector, or if the operating software image associated with the boot location vector is invalid, the boot code will add a new boot location vector to the boot vector table that points to the appropriate validated operating software image. This enables start-up operations to be expedited by the boot code during subsequent power-up sequences.

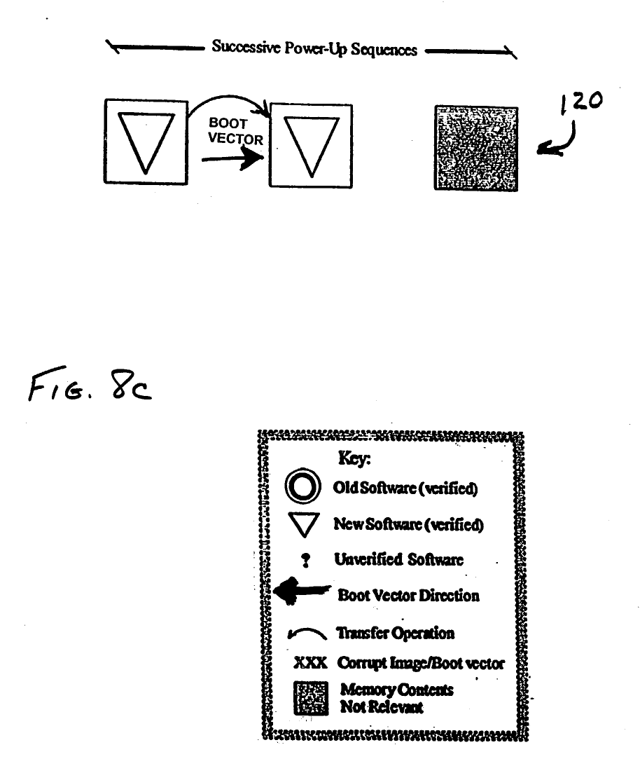

Referring to FIGS. 7-8, the inventive fault-tolerant reprogramming method to remotely upgrade device operating parameters, such as operating software, will be described. The inventive reprogramming method described herein can be performed while the WCD or other medical device is in use by a patient. During a normal power-up sequence of the WCD device, the boot vector table will include a valid boot location vector pointing to the main memory area. The boot code copies the current operating software image from the main memory area into the runtime memory area for execution (step 100). Execution of the current operating software image begins from the runtime memory area.

During a normal data download sequence, the WCD device is connected to the remote location, via the communications network, by any of the previously described connection means. During the normal data download sequence, a remote server at the remote location queries the WCD device's current operating software version to determine if an update or upgrade is required (step 102). Typically, the remote server will query the device's current operating software version after completion of the data download to the remote location. However, the remote server may query the device to determine whether an upgrade is required either before, during or after the data download without departing from the spirit and scope of the present invention.

If the remote server determines at step 102 that a software upgrade is required, the alternate memory area is erased (step 104). Such erasure is accomplished by the remote server commanding the WCD device to prepare the alternate memory area for the upgraded new operating software image.

Once the alternate memory area has been erased, the remote server will be begin downloading the new operating software image to the WCD device which, in turn, stores the downloaded new operating software image in the alternate memory area (step 106). It should be noted that during software downloading, the boot vector table remains unchanged and the valid boot vector still points to the main memory area which contains the current operating software version. Thus, should downloading of the new operating software fail to complete, due to a power failure or other reason, the WCD device will continue to use its current operating software version during subsequent power-up sequences.

Once the downloading of the upgraded operating software, or firmware, is complete, the integrity of the new operating software image in the alternate memory area is then verified by the WCD device by performing a CRC test or other error checking method. If the new operating software image stored in the alternate memory area is verified, the WCD device adds a new boot vector to the boot vector table that will cause the device to execute the new operating software image located in the alternate memory area during the device's next power-up sequence (step 108). This new boot vector will point to the alternate memory area and will include the CRC valve that is stored in the new operating software image. Until such time as the new operating software is verified at step 108 and the boot vector table updated, the WCD device will continue to load and execute the valid current operating software version stored in the main memory. In this manner, should verification fail at step 108, the device can continue to operate utilizing its current software version stored in the main memory area. Further, the WCD device will continue to execute the current software version, utilizing it to monitor the patient and store data until the device power is cycled.

During the device's next power-up sequence, the boot code is executed prior to the main operating software. As previously noted, the boot code selects the appropriate operating software image for execution by utilizing the boot location vectors the boot vector table. The boot code retrieves the most recently entered boot vector from the boot vector table, which boot vector contains a pointer to a non-volatile memory area, the alternate memory area in this case, and a CRC or other error check value. The boot code then examines the operating software image in the alternate memory area indicated by the boot vector in the boot vector table, and verifies the software image using a CRC error check or other error checking method. If, for example, the CRC error check word in the boot vector matches the CRC error check word built into the new operating software image in the alternate memory area, the new operating software image is copied to the runtime memory area for execution (step 110).

Once the new operating software has begun executing and performing various start-up operations in the runtime memory area, the current operating software version in the main memory area is replaced with the new operating software version. Specifically, the current operating software image is erased from the main memory area (step 112). The WCD device then copies the new operating software image into the main memory area (step 114). As shown at step 114, the new operating software image can be copied from either the alternate memory area or the runtime memory area where it is currently being executed.

Once the new operating software image has been copied into the main memory area, the WCD device verifies the successful copying of the new operating software image by performing a CRC calculation, or other error checking method, on the copied new operating software image located in the main memory area. Once the new operating software image in the main memory area has been verified, the WCD device adds a new boot vector entry to the boot vector table that will cause the WCD device to load the new operating software image from the main memory area during subsequent power-up sequences (step 116). Until the new operating software in the main memory area has been verified, the most recent boot vector entry in the boot vector table will continue to point to the new operating software stored in the alternate memory area. Thus, if there are any errors in copying the new operating software to the main memory area, the boot vector table will still include a valid boot vector pointing to valid operating software (new operating software version) in the alternate memory area.

After the new operating software in the main memory area has been verified and the boot vector table updated at step 116, the alternate memory area may be erased (step 118). However, erasing the alternate memory area at step 118 is optional, since once the inventive reprogramming method determines that a software upgrade is required, the alternate memory area will be erased and prepared for upgrading at step 104.

After the alternate memory area has been erased at step 118, the updating sequence is complete, and during subsequent or successive power-up sequences of the WCD device, the boot code will copy the new operating software image from the main memory area into the runtime memory area for execution (step 120).

The inventive reprogramming method thus provides a reliable fault-tolerant method for remotely updating the operating software in a computer controlled WCD device, in which reprogramming or upgrading interruptions and/or faults will not result in device malfunction. All operating software code and other sensitive data are tagged with an integrity check word, such as a CRC value or other error check word. The error check word is utilized to verify the integrity of the operating software, or data, that is essential to the proper operation of the WCD device. The WCD device also contains a sufficient quantity of non-volatile memory space to facilitate the fault-tolerant reprogramming method while the device continues to monitor a patient. The ability to maintain back-up copies of operational software, or firmware, and data is essential to the fault-tolerant operation of the inventive reprogramming process.

The inventive remote reprogramming operations of the present invention will typically be executed in a defined sequence. Each successive step in the upgrading process will typically only be initiated if the preceding step is executed properly arid the result is verified. No individual sequence failure is capable of disabling or inappropriately altering the WCD device operation. Excluding hardware failures, the worst case scenario of an upgrading failure is that the WCD device will revert back to the current operating software parameters that were in effect just prior to initiation of the reprogramming process. During subsequent communications with the WCD device during data download sequences, the remote server is capable of detecting a failure in the upgrading process and, if detected, is capable of reinitiating the upgrading process.

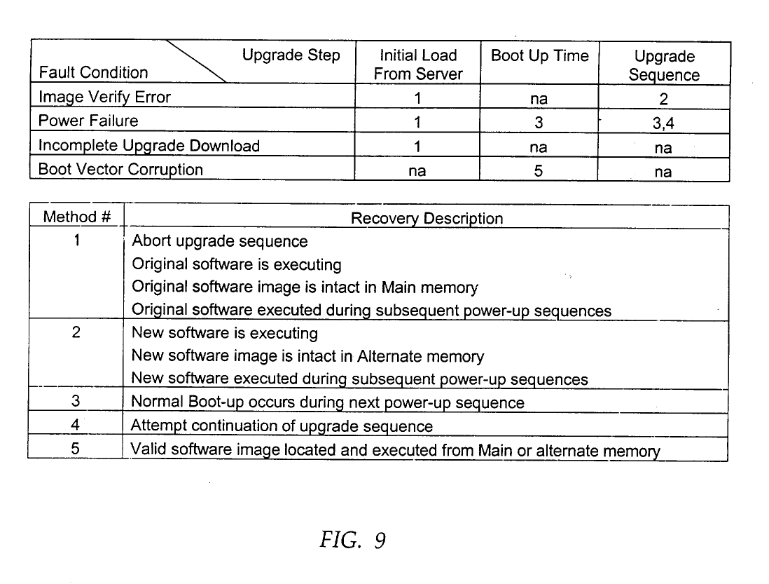

FIG. 9 is a table illustrating the possible failure modes, or fault conditions, that can occur during the reprogramming process of the inventive method. Also illustrated in FIG. 9 are the various measures that can be taken to recover from each failure mode to ensure continued operation of the WCD device. As shown in FIG. 9, typically four fault conditions can occur during the reprogramming procedure, namely, image verify error, power failure, incomplete upgrade download and boot vector corruption. These fault conditions may or may not occur during various steps of the reprogramming procedure.

For example, should a fault condition, or error, occur during the initial download of the new operating software from the remote server (steps 100, 102, 104, 106 and 108), the reprogramming procedure is aborted and the current operating software version in the main memory area continues to execute, is kept intact, and is executed by the WCD device during subsequence power-up sequences. Should a fault condition occur during the boot up time, i.e., the time it takes the boot code to locate a valid boot location vector in the boot vector table, one of two recovery methods can occur. If the WCD device experiences a power failure, a normal boot-up sequence will occur during the device's next power-up sequence. If the error includes a boot vector corruption error, the boot code will go to the next boot vector entry, etc., and scan the boot vector table for a valid boot location vector. Valid operating software corresponding to the valid boot location vector will be located and loaded/executed from the main or alternate memory area.

During the upgrade sequence of the inventive reprogramming method (steps 110, 112, 114, 116 and 118), if an image verify error occurs, the recovery method will include keeping the new operating software image that is executing intact in the alternate memory area, and executing the new operating software during subsequent power-up sequences. If, during the upgrade sequence, the WCD device experiences a power failure, the recovery method can either include performing a normal boot-up sequence during the next power-up sequence, or attempting a continuation of the upgrade sequence during the device's next power-up sequence.

Those skilled in the art will appreciate that the inventive reprogramming method is a fail-safe way to remotely update the operating software of a WCD device, while the device remains in operation monitoring a patient. Power failures and other upgrading interruptions and faults will not result in malfunction of the WCD device. The worst case outcome of an updating fault is the continued operation of the WCD device using valid operating software data stored in a non-volatile memory area.

While specific embodiments of practicing the invention have been described in detail, it will be appreciated by those skilled in the art that various modifications and alternatives could be developed in light of the overall teachings of the disclosure without departing from the spirit and scope of the present invention. Specifically, while the inventive method disclosed herein has been described for use with a wearable cardioverter defibrillator, any medical device, or simply any device in general, may incorporate the inventive reprogramming method without departing from the spirit and scope of the present invention. Accordingly, the particular arrangements disclosed herein are meant to be illustrative only and not limiting in any way to the scope of the invention which is to be given the full breadth of the foregoing description and appended claims and any and all equivalents.

We claim:

1. A method of remotely updating operating software for a device, the method comprising the steps of:
downloading new operating software from a remote server to the device;
storing the downloaded new operating software in a first memory in the device; and
adding a first new vector to a boot vector table, wherein the first new vector will cause the device to load the new operating software from the first memory for execution during a next power-up sequence.

2. The method of claim 1, wherein the device comprises a medical device operatively attachable to a patient for monitoring and recording patient medical data, and wherein the downloading, storing and adding steps are all performed automatically during a data download sequence.

3. The method of claim 2, wherein the medical device comprises a wearable cardioverter defibrillator.

4. The method of claim 1, further comprising the step of verifying the downloaded new operating software, wherein the first new vector is added to the boot vector table only if the downloaded new operating software passes the verification step.

5. The method of claim 4, wherein the verifying step comprises performing a cyclic redundancy check on the downloaded new operating software.

6. The method of claim 1, wherein during the next power-up sequence, the method further comprises the steps of:
copying the new operating software from the first memory to a second memory in the device for execution;
erasing old operating software from a third memory in the device;
copying the new operating software to the third memory; and
adding a second new vector to the boot vector table, wherein the second new vector will cause the device to load the new operating software from the third memory for execution during subsequent power-up sequences,

7. The method of claim 6, further comprising the step of verifying the new operating software in the first memory, wherein the new operating software is copied to the second memory only if the new operating software in the first memory passes the verification step.

8. The method of claim 6, further comprising the step of executing the new operating software in the second memory, wherein the old operating software is erased from the third memory only after the new operating software has begun executing.

9. The method of claim 6, further comprising the step of verifying the new operating software in the third memory, wherein the second new vector is added to the boot vector table only if the new operating software in the third memory passes the verification step.

10. The method of claim 6, further comprising the step of erasing the first memory after the second new vector has been added to the boot vector table.

11. A method of remotely updating operating software for a medical device for monitoring patient medical data, the medical device storing the monitored medical data and transmitting the stored medical data, via a communications network, to a remote location during a data download sequence, the method comprising the steps of:
querying the medical device's current operating software to determine if an update is required, the current operating software stored in the first memory in the medical device; and
if an update is required,
downloading new operating software from a remote server to a second memory in the medical device;
verifying the downloaded new operating software in the second memory;
if the downloaded new operating software in the second memory passes the verification step, configuring the medical device to load the new operating software from the second memory for execution during a next power-up sequence; and
if the downloaded new operating software in the second memory does not pass the verification step, continuing to load the current operating software from the first memory for execution during the next power-up sequence.

12. The method of claim 11, wherein the configuring step comprises adding a first new vector to a boot vector table, wherein the first new vector will cause the medical device to load the new operating software from the second memory for execution during the next power-up sequence.

13. The method of claim 11, wherein if an update is required and the downloaded new operating software in the second memory passed the verification step, the method further comprising the steps of:
during the next power-up sequence,
loading the new operating software from the second memory for execution;
replacing the current operating software in the first memory with the new operating software;
verifying the new operating software in, the first memory;
if the new operating software in the first memory passes the verification step, configuring the medical device to load the new operating software from the first memory for execution during subsequent power-up sequences; and
if the new operating software in the first memory does not pass the verification step, continuing to load the new operating software from the second memory for execution during subsequent power-up sequences.

14. The method of claim 13, wherein the replacing step comprises the steps of:
deleting the current operating software from the first memory; and
copying the new operating software to the first memory.

15. The method of claim 13, wherein the configuring step comprises adding a second new vector to the boot vector table, wherein the second new vector will cause the medical device to load the new operating software from the first memory for execution during subsequent power-up sequences.

16. The method of claim 13, further comprising the step of executing the loaded new operating software, wherein the replacing step is not performed until after the new operating software has begun executing.

17. The method of claim 13, further comprising the step of verifying the new operating software in the second memory prior to the loading step, wherein the new operating software is loaded for execution only if the new operating software in the second memory passes the verification step.

18. The method of claim 13, wherein if the new operating software in the first memory passes the verification step, the method further comprises the step of erasing the second memory.

19. The method of claim 11, wherein the medical device comprises a wearable cardioverter defibrillator, and wherein the patient medical data comprises electrocardiogram data of the patient's heart rhythm.

20. The method of claim 11, wherein the querying, downloading, verifying and configuring steps are all performed automatically during a data download sequence.

21. The method of claim 20, wherein the querying, downloading, verifying and configuring steps are all performed automatically after the patient medical data has been downloaded to the remote location during the data download sequence.

22. A method of remotely updating operating software for a medical device for monitoring patient medical data, the medical device storing the monitored medical data and transmitting the stored medical data, via a communications network, to a remote location during a data download sequence, the method comprising the steps of:
during a data download sequence, automatically
determining that the medical device's current operating software needs to be updated, the current operating software stored in a first memory in the medical device;
downloading new operating software from a remote server to a second memory in the medical device;
verifying the downloaded new operating software in the second memory; and
if the downloaded new operating software in the second memory passes the verification step, configuring the medical device to load the new operating software from the second memory for execution during a next power-up sequence.

23. The method of claim 22, further comprising the step of:
if an error condition occurs at any of the determining, downloading, verifying and configuring steps, loading the current operating software from the first memory for execution during the next power-up sequence.

24. The method of claim 22, wherein the configuring step comprises adding a first new vector to a boot vector table, wherein the first new vector will cause the medical device to load the new operating software from the second memory for execution during the next power-up sequence.

25. The method of claim 22, further comprising the steps of:
during the next power-up sequence, automatically
verifying the new operating software in the second memory;
if the new operating software in the second memory passes the verification step, loading the new operating software from the second memory for execution; and
if the new operating software in the second memory does not pass the verification step, loading the current operating software from the first memory for execution.

26. The method of claim 22, further comprising the steps of:
during the next power-up sequence, automatically
loading the new operating software from the second memory for execution;
executing the loaded new operating software;
replacing the current operating software in the first memory with the new operating software; and
configuring the medical device to load the new operating software from the first memory for execution during subsequent power-up sequences.

27. The method of claim 26, wherein the configuring step comprises adding a second new vector to the boot vector table, wherein the second new vector will cause the medical device to load the new operating software from the first memory for execution during subsequent power-up sequences.

28. The method of claim 26, wherein the replacing step comprises the steps of:
deleting the current operating software from the first memory; and
copying the new operating software to the first memory.

29. The method of claim 28, further comprising the step of verifying the copied new operating software in the first memory, wherein the medical device is configured to load the new operating software from the first memory for execution during subsequent power-up sequences only if the new operating software in the first memory passes the verification step.

30. The method of claim 29, wherein if the new operating software in the first memory does not pass the verification step, continuing to load the new operating software from the second memory for execution during subsequent power-up sequences.

31. The method of claim 26, wherein the replacing step is performed only after the new operating software has begun executing.

32. The method of claim 22, wherein the medical device comprises a wearable cardioverter defibrillator, and wherein the patient medical data comprises electrocardiogram data of the patient's heart rhythm.

33. The method of claim 22, wherein the determining, downloading, verifying and configuring steps are all performed automatically after the patient medical data has been downloaded to the remote location during the data download sequence.
